(19) United States
(12) Patent Application Publication
(10) Pub. No.: US 2006/0168051 A1
(43) Pub. Date: Jul. 27, 2006

(54) Limited-use instant messaging accounts

(75) Inventors: Edward K.Y. Jung, Bellevue, WA (US); Royce A. Levien, Lexington, MA (US); Mark A. Malamud, Seattle, WA (US); John D. Rinaldo JR., Bellevue, WA (US)

Correspondence Address: Searete LLC;Suite 110, 1756-114th Ave. S.E., Bellevue, WA, 98004, US

(73) Assignee: Searete LLC, a limited liability corporation of the State Delaware

(21) Appl. No.: 11/111,488

(22) Filed: Apr. 20, 2005

Related U.S. Application Data
(63) Continuation-in-part of application No. 11/041,894, filed on Jan. 21, 2005.
(63) Continuation-in-part of application No. 11/046,224, filed on Jan. 28, 2005.
(63) Continuation-in-part of application No. 11/066,728, filed on Feb. 25, 2005.
(63) Continuation-in-part of application No. 11/087,727, filed on Mar. 22, 2005.
(63) Continuation-in-part of application No. 11/107,343, filed on Apr. 15, 2005.

(51) Int. Cl. G06F 15/16

(52) U.S. Cl. 709/206

(57) ABSTRACT

In one aspect, a method related to a limited-use instant messaging account. In addition to the foregoing, other method and system and program product aspects are described in the claims, drawings, and text forming a part of the present application.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith. The United States Patent Office (USPTO) has published a notice to the effect that the USPTO's computer programs require that patent applicants reference both a serial number and indicate whether an application is a continuation or continuation in part. The present applicant entity has provided below a specific reference to the application(s) from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

### RELATED APPLICATIONS

1. For purposes of the USPTO extra-statutory requirements, the present application constitutes a continuation in part of currently co-pending U.S. patent application entitled LIMITED-LIFE ELECTRONIC MAIL ACCOUNT AS INTERMEDIARY, naming Paul G. Allen; Edward K. Y. Jung; Royce A. Levien; Mark A. Malamud; and John D. Rinaldo, Jr. as inventors, U.S. application Ser. No. 11/041,894, filed Jan. 21, 2005, by express mail.

2. For purposes of the USPTO extra-statutory requirements, the present application constitutes a continuation in part of currently co-pending U.S. patent application entitled LIMITED-LIFE ELECTRONIC MAIL ACCOUNTS naming Paul G. Allen; Edward K. Y. Jung; Royce A. Levien; Mark A. Malamud; and John D. Rinaldo, Jr. as inventors, U.S. application Ser. No. 11/046,224, filed Jan. 28, 2005, by express mail.

3. For purposes of the USPTO extra-statutory requirements, the present application constitutes a continuation in part of currently co-pending U.S. patent application entitled LIMITED-OPERATION ELECTRONIC MAIL ACCOUNTS WITH SET FUNCTIONS naming Paul G. Allen, Edward K. Y. Jung; Royce A. Levien; Mark A. Malamud; and John D. Rinaldo, Jr. as inventors, U.S. application Ser. No. 11/066,728, filed Feb. 25, 2005, by express mail.

4. For purposes of the USPTO extra-statutory requirements, the present application constitutes a continuation in part of currently co-pending U.S. patent application entitled INTERFACE FOR CREATION OF LIMITED-USE ELECTRONIC MAIL ACCOUNTS naming Edward K. Y. Jung; Royce A. Levien; Mark A. Malamud; and John D. Rinaldo, Jr. as inventors, U.S. application Ser. No. 11/087,727, filed Mar. 22, 2005, by express mail.

5. For purposes of the USPTO extra-statutory requirements, the present application constitutes a continuation in part of currently co-pending U.S. patent application entitled MANAGING A LIMITED-USE ELECTRONIC MAIL ACCOUNT naming Edward K. Y. Jung; Royce A. Levien; Mark A. Malamud; and John D. Rinaldo, Jr. as inventors, U.S. application Ser. No. [to be assigned] filed Apr. 15, 2005, by express mail.

### TECHNICAL FIELD

The present application relates, in general, to instant messaging.

### SUMMARY

In one aspect, a method related to instant messaging includes but is not limited to creating a limited-use instant messenger alias related to a limited-use instant message account user; and mediating one or more message exchanges between the limited-use instant message account user and a specified messaging party. In addition to the foregoing, other method aspects are described in the claims, drawings, and text forming a part of the present application.

In one aspect, a system related to instant messaging includes but is not limited to: circuitry for creating a limited-use instant messenger alias related to a limited-use instant message account user; and circuitry for mediating one or more message exchanges between the limited-use instant message account user and a specified messaging party. In addition to the foregoing, other system aspects are described in the claims, drawings, and text forming a part of the present application.

In one or more various aspects, related systems include but are not limited to circuitry and/or programming and/or electromechanical devices and/or optical devices for effecting the herein-referenced method aspects; the circuitry and/or programming and/or electromechanical devices and/or optical devices can be virtually any combination of hardware, software, and/or firmware configured to effect the herein-referenced method aspects depending upon the design choices of the system designer skilled in the art.

In one aspect, a program product includes but is not limited to: a signal bearing medium bearing one or more instructions for creating a limited-use instant messenger alias related to a limited-use instant message account user, and one or more instructions for mediating one or more message exchanges between the limited-use instant message account user and a specified messaging party. In addition to the foregoing, other program product aspects are described in the claims, drawings, and text forming a part of the present application.

In addition to the foregoing, various other method, system, and/or program product aspects are set forth and described in the teachings such as the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 is depicts one implementation of an exemplary environment in which the methods and systems described herein may be represented;

FIG. 2 depicts a high-level flowchart of an operational process;

FIG. 3 illustrates several alternate implementations of the high-level logic flowchart of FIG. 2;

FIG. 4 illustrates several alternate implementations of the high-level logic flowchart of FIG. 2;

FIG. 5 shows several alternative implementations of the high-level logic flowchart of FIG. 2;

FIG. 6 shows several alternative implementations of the high-level logic flowchart of FIG. 2; and

FIG. 7 shows several alternative implementations of the high-level logic flowchart of FIG. 2.

The use of the same symbols in different drawings typically indicates similar or identical items.

### DETAILED DESCRIPTION

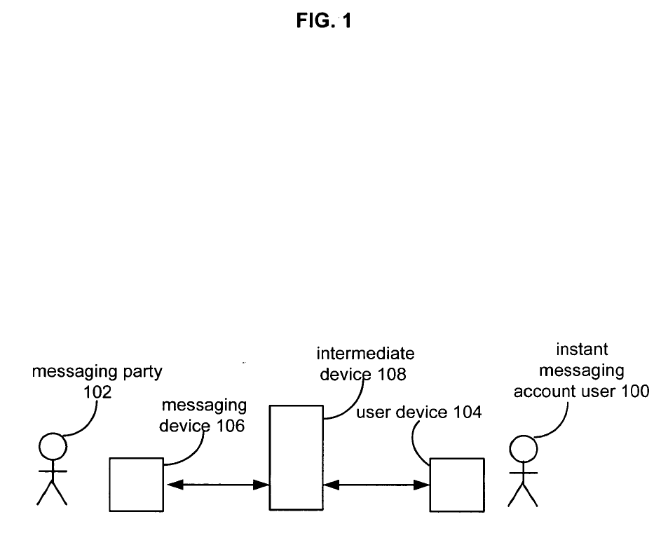

With reference to the figures, FIG. 1 depicts one implementation of an exemplary environment in which the methods and systems described herein may be represented. The limited-use instant message account user 100 is the recipient and sender of messages by means of a limited-use instant message account (hereinafter “user 100”) to and from, respectively, messaging party 102, which is representative of one or more messaging parties. The user 100 uses user device 104, which may be one or more of a wireless handheld device, a laptop computer, a personal computer, a desk computer, a computer system terminal, or any other device capable of providing an interface between the user 100 and an instant messaging account with which instant messages may be received and sent. The messaging party 102 uses a messaging device 106 which may be one or more of a wireless handheld device, a laptop computer, a personal computer, a desk computer, a computer system terminal, or any other device capable of providing the messaging party 102 with the capability of sending and receiving instant messages with respect to the instant messaging account of user 100. Intermediate device 108 is exemplary of any and all intermediate devices that may provide paths and/or computational resources, e.g., one or more instant messaging servers and/or transmission media, to mediate the exchange of instant messages between the user 100 and the messaging party 102 via the user device 104 and the messaging device 106. As used herein, the term “message exchange” includes but is not limited to the conveyance and/or transmission of a single instant message from the user 100 to the messaging party 102 or from the messaging party 102 to the user 100.

At least the user device 104 or the intermediate device 108, operating independently or together, are capable of creating a limited-use instant messenger alias related to a limited-use instant message account user, of mediating one or more message exchanges between the limited-use instant message account user and a specified messaging party, and/or of mediating transmission of a substitute instant messaging alias with respect to the specified messaging party depending on the specific implementation.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

Following are a series of flowcharts depicting implementations of processes. For ease of understanding, the flowcharts are organized such that the initial flowcharts present implementations via an overall “big picture” viewpoint and thereafter the following flowcharts present alternate implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

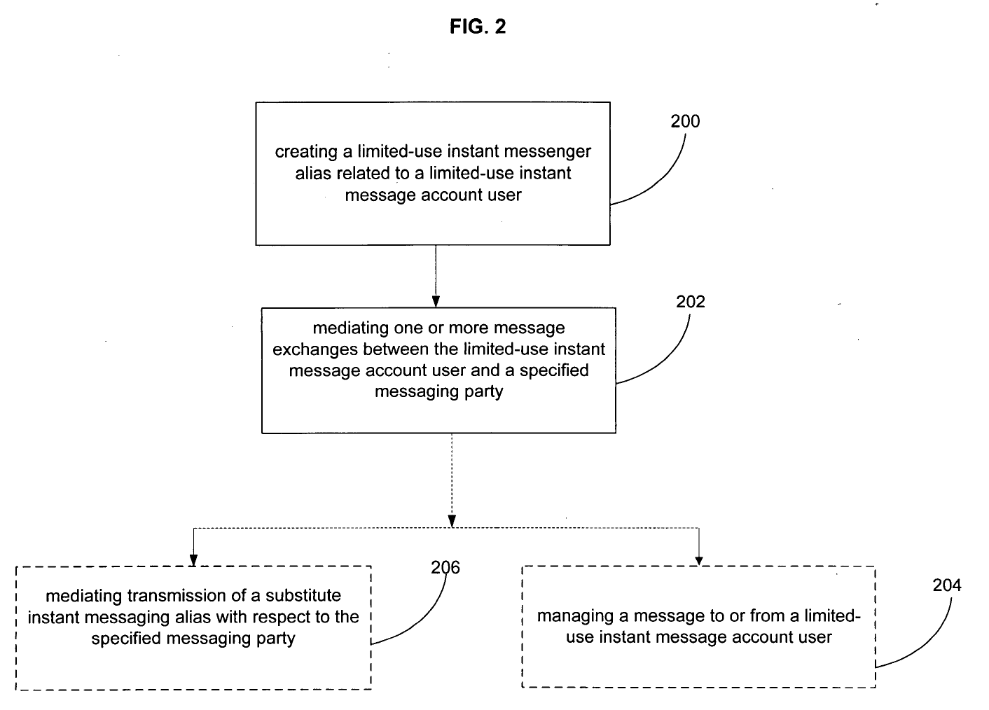

FIG. 2 depicts high-level flowcharts of various operational processes. Operation 200 shows creating a limited-use instant messenger alias related to a limited-use instant message account user. Operation 202 shows mediating one or more message exchanges between the limited-use instant message account user and a specified messaging party. Operation 204 shows an optional operation of managing a message to or from a limited-use instant message account user. Operation 206 shows an optional operation of mediating transmission of a substitute instant messaging alias with respect to the specified messaging party. Operations 204 and 206 need not take place in any particular order with reference to operation 202.

The exemplary environment of FIG. 1 can serve to illustrate examples of operations described herein. In one example at least partially illustrative of operation 200, the user 100 requests the creation of a limited-use instant messenger alias associated with a limited-use instant message account by intermediate device 108 using the user device 104. In response, intermediate device 108 creates the limited-use instant messenger alias. In one example at least partially illustrative of operation 202, the intermediate device 108, using hardware/firmware/software embodied logic of the intermediate device 108, mediates one or more message exchanges between the user 100 and a specified messaging party such as 102, where messaging party 102 uses the messaging device 106, using hardware/firmware/software embodied logic of the messaging device 106, to send and/or receive instant messages with respect to the user 100. In one example at least partially illustrative of operation 204, the intermediate device 108, using hardware/firmware/software embodied logic of the intermediate device 108, manages messages having to do with the administration of the limited-use instant message account of the user 100; management of such messages may include generation of requests directed to the user 100 and receipt of replies to requests from the user 100. In one example at least partially illustrative of operation 206, the intermediate device 108, using hardware/firmware/software embodied logic of the intermediate device 108, mediates transmission of a substitute instant messaging alias with respect to a specified massaging party such as messaging party 102; such a substitute instant messaging alias may be an instant messaging alias for an instant messaging account associated by the user 100 with more general operations than his limited-use instant messenger alias and the associated limited-use instant message account, provided to the messaging user 102 after a certain level of trust has been developed between the user 100 and the messaging party 102, and the mediation may include processing a request to provide the substitute instant messaging alias and then providing the substitute instant messaging alias.

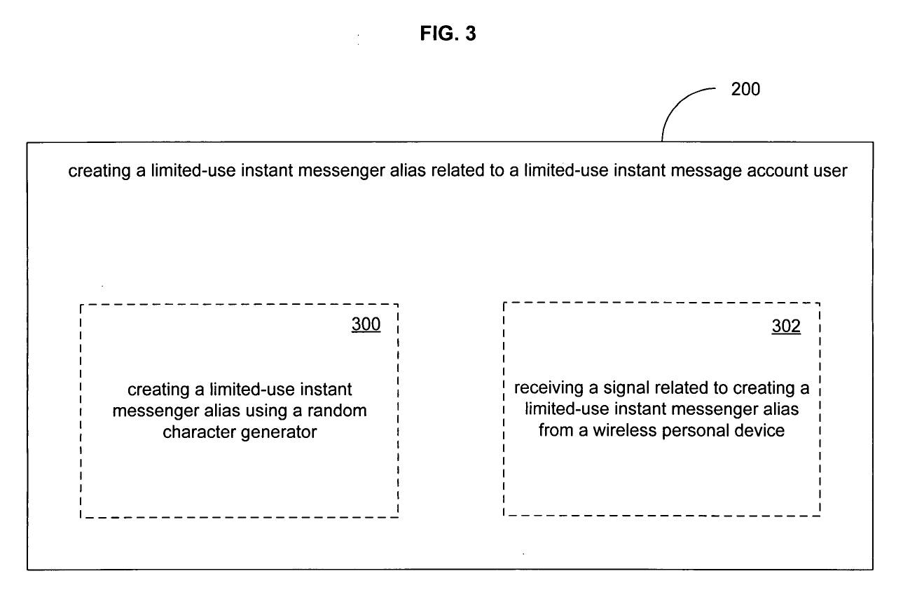

FIG. 3 illustrates alternate implementations of the high-level logic of flowchart of FIG. 2. Depicted is that various alternative implementations of operation 200—creating a limited-use instant messenger alias related to a limited-use instant message account user—may include an operation 300 and/or an operation 302. Operation 300 depicts an optional operation of creating a limited-use instant messenger alias using a random character generator (e.g., via hardware/firmware/software embodied logic of intermediate device 108, using input from the user 100 via the user device 102 and output from a random number generator to generate a random set of characters to use as an alias). Operation 302 depicts an optional operation of receiving a signal related to creating a limited-use instant messenger alias from a wireless personal device (e.g., via hardware/firmware/software embodied logic of intermediate device 108, receiving input from the user 100 via a user device 102, such as a Blackberry® personal messaging device, a signal carrying a request and/or required parameters to create the desired limited-use instant messenger alias).

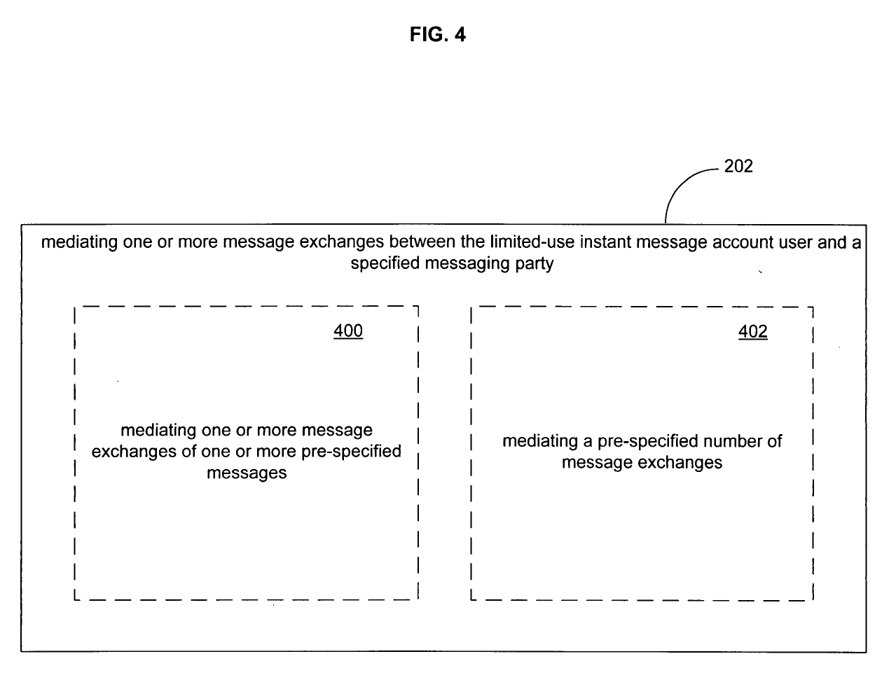

FIG. 4 illustrates an alternate implementation of the high-level logic flowchart of FIG. 2. Depicted is that various alternative implementations of operation 202—mediating one or more message exchanges between the limited-use instant message account user and a specified messaging party—may include an operation 400 and/or 402. Operation 400 shows an optional operation of mediating one or more message exchanges of one or more pre-specified messages (e.g., via hardware/firmware/software embodied logic of intermediate device 108, receiving a pre-specified instant message (e.g., a pre-specified message that an agreed-upon event has occurred) from the user 100 via the user device 102, the message being originated using the limited-use instant messenger alias and the associated limited-use instant message account of user 100, and transmitting that message to a specified messaging party such as messaging party 102 via messaging device 106). Operation 402 shows an optional operation of mediating a pre-specified number of message exchanges (e.g., via hardware/firmware/software embodied logic of intermediate device 108 receiving an instant message from the user 100 via the user device 102, the message being originated using the limited-use instant messenger alias and the associated limited-use instant message account of user 100; transmitting that message to a specified messaging party such as messaging party 102 via messaging device 106; receiving a reply instant message from the messaging party 102 via messaging device 106 and transmitting that reply to the user 100 via the user device 102, where the pre-specified number of message exchanges is two).

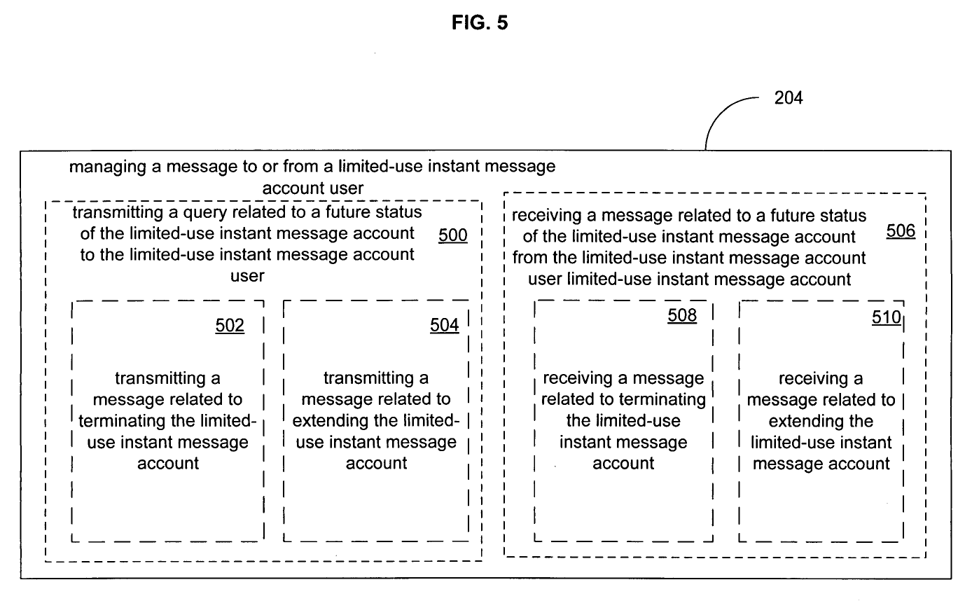

FIG. 5 shows several alternative implementations of the high-level logic flowchart of FIG. 2. Depicted is that one alternative implementation of operation 204—managing a message to or from a limited-use instant message account user—may include operation 500, which illustrates transmitting a query related to a future status of the limited-use instant message account to the limited-use instant message account user (e.g., via hardware/firmware/software embodied logic of intermediate device 108 transmitting to the user 100 via user device 102 a message related to a pending termination of the limited-use instant message account). Operation 500 may include optional operations 502 and/or 504. Operation 502 shows an optional operation of transmitting a message related to terminating the limited-use instant message account (e.g., via hardware/firmware/software embodied logic of intermediate device 108 transmitting to the user 100 via user device 102 a notice of termination of the limited-use instant message account when a pre-specified number of message exchanges have been mediated). Operation 504 depicts an optional operation of transmitting a message related to extending the limited-use instant message account (e.g., via hardware/firmware/software embodied logic of intermediate device 108 transmitting to the user 100 via user device 102 a notice of extension of the term of the limited-use instant message account of user 100 upon satisfaction of pre-specified criteria such as payment for the account).

In one alternative implementation, operation 204 may include operation 506, which illustrates receiving a message related to a future status of the limited-use instant message account from the limited-use instant message account user limited-use instant message account (e.g., via hardware/firmware/software embodied logic of intermediate device 108 receiving from the user 100 via user device 102 a request related to extending the limited-use instant message account). Operation 506 may include optional operations 508 and/or 510. Operation 508 shows an optional operation of receiving a message related to terminating the limited-use instant message account (e.g., via hardware/firmware/software embodied logic of intermediate device 108 receiving from the user 100 via user device 102 a request for termination of the limited-use instant message account upon satisfaction of pre-specified criteria (e.g., mediation of a pre-specified number of mediated message exchanges)). Operation 510 depicts an optional operation of receiving a message related to extending the limited-use instant message account (e.g., via hardware/firmware/software embodied logic of intermediate device 108 receiving from the user 100 via user device 102 a request for extension of the term of the limited-use instant message account of user 100, the extension to be performed upon satisfaction of pre-specified criteria such as payment for the account via credit card).

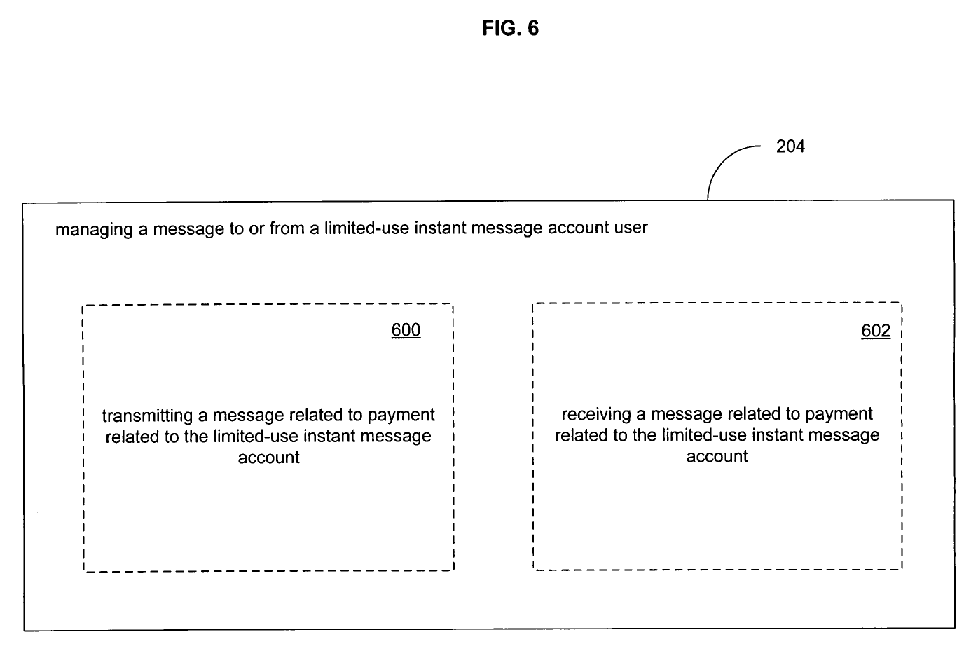

FIG. 6 shows several alternative implementations of the high-level logic flowchart of FIG. 2. Depicted is that various alternative implementations of operation 204—managing a message to or from a limited-use instant message account user—may include operations 600 and/or 602. Operation 600 illustrates an optional operation of transmitting a message related to payment related to the limited-use instant message account (e.g., via hardware/firmware/software embodied logic of intermediate device 108 transmitting to the user 100 via user device 102 a request for data sufficient to allow processing of a payment for the account via credit card (e.g., a request for credit card type, number, and/or expiration date)). Operation 602 shows an optional operation of receiving a message related to payment related to the limited-use instant message account (e.g., via hardware/firmware/software embodied logic of intermediate device 108 receiving from the user 100 via user device 102 data sufficient to allow processing of a payment for the account via credit card (e.g., credit card type, number, and/or expiration date)).

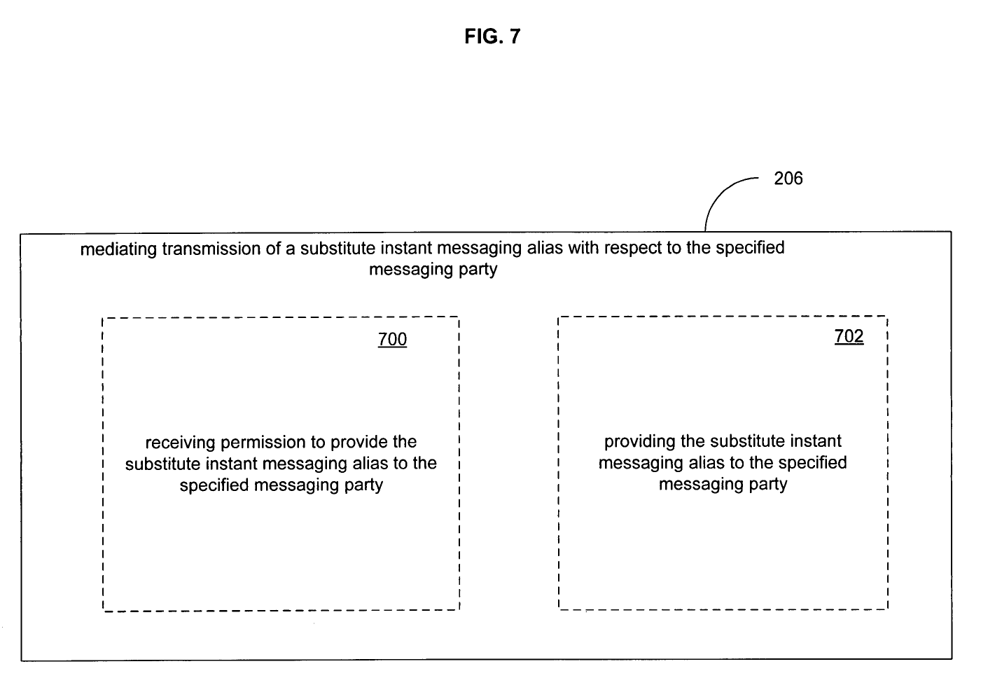

FIG. 7 shows several alternative implementations of the high-level logic flowchart of FIG. 2. Depicted is that various alternative implementations of operation 206—mediating transmission of a substitute instant messaging alias with respect to the specified messaging party—may include operations 700 and/or 702. Operation 700 shows an alternative operation of receiving permission to provide the substitute instant messaging alias to the specified messaging party (e.g., via hardware/firmware/software embodied logic of intermediate device 108 receiving from the user 100 via the user device 102 a request constituting permission to provide a publicly known instant messaging alias of the user 100 to a specified messaging party such as the messaging party 102). Operation 702 depicts an alternative operation of providing the substitute instant messaging alias to the specified messaging party (e.g., via hardware/firmware/software embodied logic of intermediate device 108 transmitting to the messaging party 102 via the messaging device 106 a publicly known instant messaging alias of the user 100).

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into image processing systems. That is, at least a portion of the devices and/or processes described herein can be integrated into an image processing system via a reasonable amount of experimentation. Those having skill in the art will recognize that a typical image processing system generally includes one or more of a system unit housing, a video display device, a memory such as volatile and non-volatile memory, processors such as microprocessors and digital signal processors, computational entities such as operating systems, drivers, and applications programs, one or more interaction devices, such as a touch pad or screen, control systems including feedback loops and control motors (e.g., feedback for sensing lens position and/or velocity; control motors for moving/distorting lenses to give desired focuses. A typical image processing system may be implemented utilizing any suitable commercially available components, such as those typically found in digital still systems and/or digital motion systems.

Those skilled in the art will recognize that it is common within the art to describe devices and/or processes in the fashion set forth herein, and thereafter use standard engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

We claim:

1. A method related to instant messaging, the method comprising:
creating a limited-use instant messenger alias related to a limited-use instant message account user; and
mediating one or more message exchanges between the limited-use instant message account user and a specified messaging party.

2. The method of claim 1, wherein the creating a limited-use instant messenger alias related to a limited-use instant message account user further comprises:
creating a limited-use instant messenger alias using a random character generator.

3. The method of claim 1, wherein the creating a limited-use instant messenger alias related to a limited-use instant message account user further comprises:
receiving a signal related to creating a limited-use instant messenger alias from a wireless personal device.

4. The method of claim 1, wherein the mediating one or more message exchanges between the limited-use instant message account user and a specified messaging party further comprises:
mediating one or more message exchanges of one or more pre-specified messages.

5. The method of claim 1, wherein the mediating one or more message exchanges between the limited-use instant message account user and a specified messaging party further comprises:
mediating a pre-specified number of message exchanges.

6. The method of claim 1, further comprising:
managing a message to or from a limited-use instant message account user.

7. The method of claim 6, wherein the managing a message to or from a limited-use instant message account user further comprises:
transmitting a query related to a future status of the limited-use instant message account to the limited-use instant message account user.

8. The method of claim 7, wherein the transmitting a query related to a future status of the limited-use instant message account to the limited-use instant message account user further comprises:
transmitting a message related to terminating the limited-use instant message account.

9. The method of claim 7, wherein the transmitting a query related to a future status of the limited-use instant message account to the limited-use instant message account user further comprises:
transmitting a message related to extending the limited-use instant message account.

10. The method of claim 6, wherein the managing a message to or from a limited-use instant message account user further comprises:
receiving a message related to a future status of the limited-use instant message account from the limited-use instant message account user limited-use instant message account.

11. The method of claim 10, wherein the receiving a message related to a future status of the limited-use instant message account from the limited-use instant message account user limited-use instant message account further comprises:
receiving a message related to terminating the limited-use instant message account.

12. The method of claim 10, wherein the receiving a message related to a future status of the limited-use instant message account from the limited-use instant message account user limited-use instant message account further comprises:
receiving a message related to extending the limited-use instant message account.

13. The method of claim 6, wherein the managing a message to or from a limited-use instant message account user further comprises:
transmitting a message related to payment related to the limited-use instant message account.

14. The method of claim 6, wherein the managing a message to or from a limited-use instant message account user further comprises:
receiving a message related to payment related to the limited-use instant message account.

15. The method of claim 1, further comprising:
mediating transmission of a substitute instant messaging alias with respect to the specified messaging party.

16. The method of claim 15, wherein the mediating transmission of a substitute instant messaging alias with respect to the specified messaging party further comprises:
receiving permission to provide the substitute instant messaging alias to the specified messaging party.

17. The method of claim 15, wherein the mediating transmission of a substitute instant messaging alias with respect to the specified messaging party further comprises:
providing the substitute instant messaging alias to the specified messaging party.

18. A system related to instant messaging, comprising:
circuitry for creating a limited-use instant messenger alias related to a limited-use instant message account user; and
circuitry for mediating one or more message exchanges between the limited-use instant message account user and a specified messaging party.

19. The system of claim 18, further comprising:
circuitry for managing a message to or from a limited-use instant message account user.

20. The system of claim 18, further comprising:
circuitry for mediating transmission of a substitute instant messaging alias with respect to the specified messaging party.

21. A system comprising:
means for creating a limited-use instant messenger alias related to a limited-use instant message account user; and
means for mediating one or more message exchanges between the limited-use instant message account user and a specified messaging party.

22. The system of claim 21, further comprising:
means for managing a message to or from a limited-use instant message account user.

23. The system of claim 21, further comprising:
means for mediating transmission of a substitute instant messaging alias with respect to the specified messaging party.

24. A program product, comprising:
a signal bearing medium bearing one or more instructions for creating a limited-use instant messenger alias related to a limited-use instant message account user, and
one or more instructions for mediating one or more message exchanges between the limited-use instant message account user and a specified messaging party.

25. The program product of claim 24, wherein the signal bearing medium comprises:
a recordable medium.

26. The program product of claim 24, wherein the signal bearing medium comprises:
a transmission medium.

27. The program product of claim 24, wherein the one or more instructions for creating a limited-use instant messenger alias related to a limited-use instant message account user further comprises:
one or more instructions for creating a limited-use instant messenger alias using a random character generator.

28. The program product of claim 24, wherein the one or more instructions for creating a limited-use instant messenger alias related to a limited-use instant message account user further comprises:
one or more instructions for receiving a signal related to creating a limited-use instant messenger alias from a wireless personal device.

29. The program product of claim 24, wherein the one or more instructions for mediating one or more message exchanges between the limited-use instant message account user and a specified messaging party further comprises:
one or more instructions for mediating one or more message exchanges of one or more pre-specified messages.

30. The program product of claim 24, wherein the one or more instructions for mediating one or more message exchanges between the limited-use instant message account user and a specified messaging party further comprises:
one or more instructions for mediating a pre-specified number of message exchanges.

31. The program product of claim 24, further comprising:
one or more instructions for managing a message to or from a limited-use instant message account user.

32. The program product of claim 31, wherein the one or more instructions for managing a message to or from a limited-use instant message account user further comprises:
one or more instructions for transmitting a query related to a future status of the limited-use instant message account to the limited-use instant message account user.

33. The program product of claim 32, wherein the one or more instructions for transmitting a query related to a future status of the limited-use instant message account to the limited-use instant message account user further comprises:
one or more instructions for transmitting a message related to terminating the limited-use instant message account.

34. The program product of claim 32, wherein the one or more instructions for transmitting a query related to a future status of the limited-use instant message account to the limited-use instant message account user further comprises:
one or more instructions for transmitting a message related to extending the limited-use instant message account.

35. The program product of claim 32, wherein the one or more instructions for managing a message to or from a limited-use instant message account user further comprises:
one or more instructions for receiving a message related to a future status of the limited-use instant message account from the limited-use instant message account user limited-use instant message account.

36. The program product of claim 35, wherein the one or more instructions for receiving a message related to a future status of the limited-use instant message account from the limited-use instant message account user limited-use instant message account further comprises:
one or more instructions for receiving a message related to terminating the limited-use instant message account.

37. The program product of claim 35, wherein the one or more instructions for receiving a message related to a future status of the limited-use instant message account from the limited-use instant message account user limited-use instant message account further comprises:
one or more instructions for receiving a message related to extending the limited-use instant message account.

38. The program product of claim 31, wherein the one or more instructions for managing a message to or from a limited-use instant message account user further comprises:
one or more instructions for transmitting a message related to payment related to the limited-use instant message account.

39. The program product of claim 31, wherein the one or more instructions for managing a message to or from a limited-use instant message account user further comprises:
one or more instructions receiving a message related to payment related to the limited-use instant message account.

40. The program product of claim 24, further comprising:
one or more instructions for mediating transmission of a substitute instant messaging alias with respect to the specified messaging party.

41. The program product of claim 40, wherein the one or more instructions for mediating transmission of a substitute instant messaging alias with respect to the specified messaging party further comprises:
one or more instructions receiving permission to provide the substitute instant messaging alias to the specified messaging party.

42. The program product of claim 40, wherein the one or more instructions for mediating transmission of a substitute instant messaging alias with respect to the specified messaging party further comprises:
one or more instructions for providing the substitute instant messaging alias to the specified messaging party.
